(19) United States
(12) Patent Application Publication
(10) Pub. No.: US 2012/0308067 A1
(43) Pub. Date: Dec. 6, 2012

(54) Headphone 3D Hearing technology

(76) Inventor: Wai Hung Ip, Hong Kong (CN)

(21) Appl. No.: 13/149,889

(22) Filed: Jun. 1, 2011

(51) Int. Cl. H04R 25/00

(52) U.S. Cl. 381/370

(57) ABSTRACT

The technology is specially designed for headphone to allow the listener to distinguish the direction and the distance from a sound source, just as if the listener is in a natural environment. The technology relies on optimizing the three factors that human being uses to distinguish sound source location and sound source distance. They are relative loudness, relative pitch and relative reverberation.

The technology makes use of the specially-designed sound box with specific construction and specific materials to re-create the 3D hearing feeling. The specially-designed sound box generates appropriate amount of reflection, reverberation and interference at different frequency range, which optimize the three principal factors.

### BRIEF DESCRIPTION OF THE DRAWINGS

Drawings are used to provide a better understanding to the technology.

FIG. 1 illustrates a headphone design for Headphone 3D Hearing technology.

FIG. 2 illustrates the cross section of headphone sound box.

FIG. 3 illustrates the explosion view of headphone sound box.

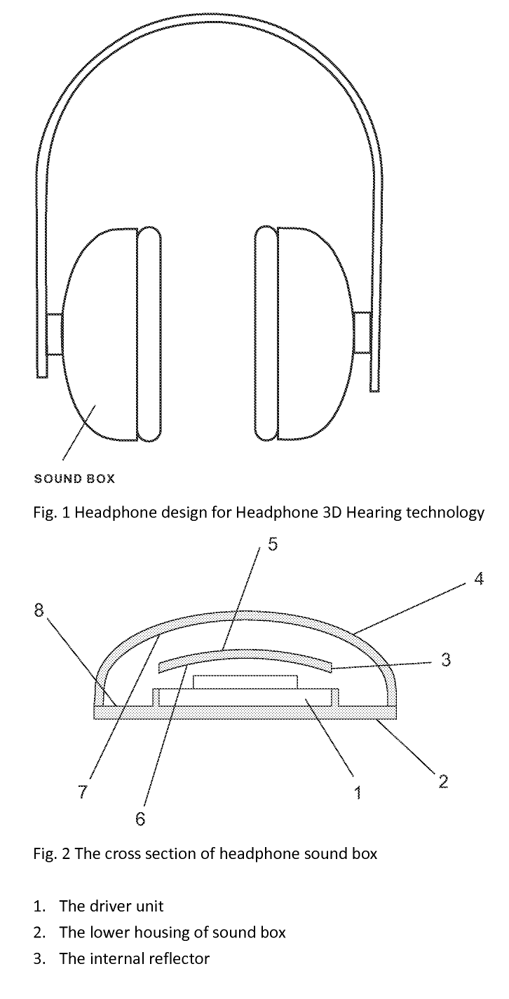

### BACKGROUND OF THE INVENTION

In a real, nature environment, human beings have the ability to hear and distinguish the location of the sound source. However in a man-made hearing environment such as headphone environment, human being loses the ability to distinguish the location of the sound source, even with the help of virtual sound effects generated by different technologies. Research has been conducted in finding the appropriate method to allow human being to distinguish the location of the sound source with headphone environment.

Concluding different research papers in human hearing and results from experiments, the ability of human beings to distinguish sound source direction is the process in the human brain, making use of three factors of sound signal. The three factors are the relative loudness of the sound signal comparing with those of the background sounds; relative pitch of the sound signal comparing with those of the background sounds; and relative reverberation of the sound signal comparing with the background sounds.

Based on the findings, Headphone 3D Hearing technology is developed by adjusting the three characteristics, the relative loudness, relative pitch and relative reverberation, in headphone environment, to re-generate the distance and direction feeling to the headphone listener, allowing the listener to be enclosed in a 3D hearing environment.

The technology is a major technological breakthrough in acoustic and 3D sound effect, as its effect has created a new standard for headphone.

The technology can be applied to the headphone to generate the distance and direction feeling to the headphone listener.

### DETAILED DESCRIPTION

The Structure of Headphone Sound Box

Headphone 3D Hearing technology requires special headphone sound box design in order to allow the technology to effect. The detail design is as FIG. 2. The headphone should contain 2 individual, identical sound boxes on each side. For each sound box, it should have a housing, where the driver ((1) of FIG. 2) should be mounted on the top surface of lower housing ((2) of FIG. 2). On the top of the driver, an internal reflector ((3) of FIG. 2) is mounted. The internal surface of upper housing ((7) of FIG. 2), internal surface of lower housing ((8) of FIG. 2), and both upper and lower surface of internal reflector ((5), (6) of FIG. 2) are covered with one or more than one special material(s).

The Theory of Operation

Headphone 3D Hearing technology makes use of the three factors of sound for human beings to distinguish distance and direction to allow the listener to be enclosed in a 3D hearing environment by listening to a specially designed headphone. The theory of operation can be described in three steps.

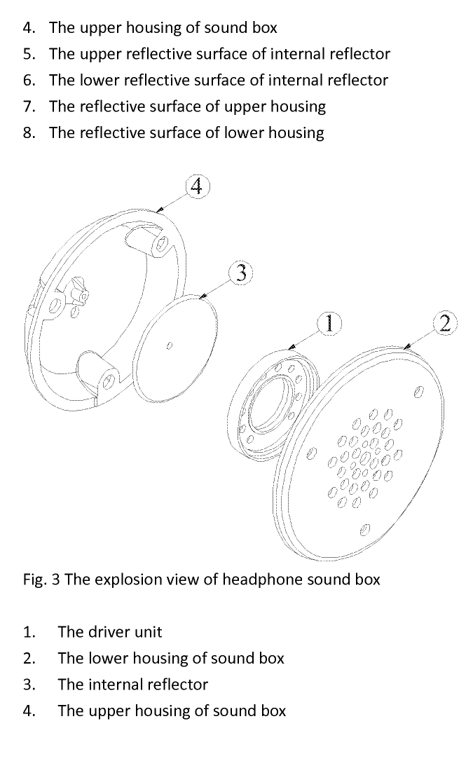

In first step, the sound wave, heard by the listener, is a combination of two different waves, namely forward wave and backward wave. The forward wave is generated by the front surface of the driver membrane, travels out of the sound box directly through the holes of the lower housing ((2) of FIG. 2 & FIG. 3). The backward wave is generated by the back surface of the driver membrane, travels in opposite direction of the forward wave and travels towards the internal reflector ((3) of FIG. 2 & FIG. 3).

In second step, the backward wave travels to the lower surface ((6) of FIG. 2) of the internal reflector ((3) of FIG. 2 & FIG. 3) and is reflected back in big percentage to the driver unit ((1) of FIG. 2 & FIG. 3). These waves hit on the driver membrane ((1) of FIG. 2 & FIG. 3) and react with successor signals to generate interference.

In third step, the small proportion of the backward wave “leaks out” of the internal reflector ((3) of FIG. 2 & FIG. 3), due to diffraction, and travels to the roof ((7) of FIG. 2) of upper housing ((4) of FIG. 2 & FIG. 3). Then, the wave is reflected. Part of the wave hits the driver unit ((1) of FIG. 2 & FIG. 3). Part of that hits the upper surface ((5) of FIG. 2) of internal reflector ((3) of FIG. 2 & FIG. 3) and reflects toward the roof of housing ((7) of FIG. 2). The other part travels to the bottom surface ((8) of FIG. 2) of the lower housing ((2) of FIG. 2 & FIG. 3) and is then reflected to the lower surface ((6) of FIG. 2) of the internal reflector ((3) of FIG. 2 & FIG. 3) as backward wave in the first step but with a phase angle. Certainly, part of that will be reflected back to the roof of upper housing ((4) of FIG. 2 & FIG. 3). The reflection is then again and again until its amplitude is highly attenuated. The number of reflections is enormous and is different to signals at different frequency, and is controlled by the reflective surfaces. Interference takes place when two of the waves (forward wave, backward wave and reflected waves) meet each other at the same location. As a result, the number of interference is enormous as well.

The upper surface ((5) of FIG. 2) and lower surface ((6) of FIG. 2) of the internal reflector ((3) of FIG. 2 & FIG. 3), the reflective surface ((7) of FIG. 2) of the upper housing ((4) of FIG. 2 & FIG. 3) and the reflective surface ((8) of FIG. 2) of the lower housing ((2) of FIG. 2 & FIG. 3) are made with specific materials. The purpose of such design is to control the degree of reflection and the degree of attenuation of signal at different frequency.

The size and shape of the internal reflector ((3) of FIG. 2 & FIG. 3) is designed carefully such that the degree of the reflection and diffraction of the sound wave at different frequency can be controlled.

Through the control of reflections at different frequency, the amplitude of the signal at different frequency has been adjusted. The adjustment modifies the frequency curve of the driver. Such modification allows the system to play back the fundamental of the signal more accurately. This helps the sound signal from low frequency to high frequency to be generated at a curve close to its original profile at recording.

The multiple reflections, mentioned in step three, generate reverberation. Such effect raises the pitch of the signal. The raise of pitch can be corrected by the surface made with specific materials, to ensure the pitch being appropriate to fulfill the requirement of 3D hearing effect.

The dome-shape design of the upper housing ((4) of FIG. 2 & FIG. 3) is to cope with the concave shaped internal reflector ((3) of FIG. 2 & FIG. 3) to allow the “focus effect” to take place. They focus the reflected sound wave to the driver unit ((1) of FIG. 2 & FIG. 3). The reflective surfaces are designed such that sound wave at high frequency will be absorbed more than that at low frequency, so the bass of the resultant wave is increased. On the other hand, under such design, constructive interference of sound wave has more effect at low frequency than at high frequency. Therefore the resultant wave has a stronger bass, particularly in ultra bass. This helps to enhance the correction of frequency curve at low frequency region.

By all of these designs, the accuracy of sound signal played back is highly closed to the original signal at both loudness at different frequency and overall pitch. The rich reverberation enhances the content of the frequency signal, the harmonic, other than its fundamental. Then, all 3 factors to hearing 3D sounds are reached.

The invention claimed as following:

1. The design of putting one or more than one reflector(s), of any shape(s) and at any position(s), inside the sound box of the headphone for the purpose of generating reflection and/or reverberation.

2. The design of putting one or more than one special material(s) onto the whole surface or part of the surface of any reflective surface inside the sound box of headphone for the purpose of controlling degree of reflection at different frequency.

3. The design of the dome shape of the housing of the sound box that helps or links to the design of the internal reflector(s) to achieve the control of reflection and/or interference of sound waves at different frequency to a desired outcome.
